(19) United States
(12) Patent Application Publication
(10) Pub. No.: US 2007/0122313 A1
(43) Pub. Date: May 31, 2007

(54) Nanochannel apparatus and method of fabricating

(76) Inventors: Zhiyong Li, Palo Alto, CA (US); M. Saif Islam, Sacramento, CA (US); Shih-Yuan Wang, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/291,019

(22) Filed: Nov. 30, 2005

(51) Int. Cl. B01L 3/00

(52) U.S. Cl. 422/100

(57) ABSTRACT

A nanochannel apparatus and method of fabrication provide an array of nanochannels with distal open or exposed ends formed in situ through a permanent support. A nanofluidic system includes the nanochannel apparatus, a fluidic interface, and a component interfaced to the nanochannel apparatus. The method includes encasing an array of nanowires in a support, and forming the array of nanochannels in situ in locations of the nanowires, such that distal ends of the nanochannels are exposed.

### CROSS-REFERENCE TO RELATED APPLICATIONS

N/A

### BACKGROUND

1. Technical Field

The invention relates to nanotechnology. In particular, the invention relates to an apparatus having embedded nanochannels with open distal ends, a nanofluidic system including the apparatus, and the fabrication of the apparatus using nanowires as templates.

2. Description of Related Art

Nanotechnology is concerned with the fabrication and application of nano-scale structures, structures having at least one linear dimension between about 1 nm and about 200 nm. These nano-scale structures are often 50 to 100 times smaller than conventional semiconductor structures. Nanowires, nanopores and nanochannels are some examples of nano-structures useful in devices, such as sensors and lasers. There are many techniques known in the art for growing or synthesizing nanowires. However, there are fewer techniques for forming a nanochannel or a nanopore. Natural materials, such as the toxin protein alpha-hemolysin, form a microscopic pathway or tunnel through a cellular membrane having a pore size in the angstrom range. However, a natural pore material has an intrinsic short life time such that their use in device manufacture is limited. A nanofluidic device having a synthetic nanochannel or nanopore capable of mimicking the pathway provided by a natural protein like alpha-hemolysin would be useful in genome sequencing, chemical sensing, biological sensing, or both, and molecule separation, for example.

Synthetic inorganic nanopores and nanochannels have been made from silicon dioxide or silicon nitride, for example, which have greater stability over time than their natural organic counterparts. One or more of ion-sculpting, TEM drilling, and nanoimprinting have been used to form the synthetic nanopores and nanochannels. Such methods of fabrication require expensive instrumentation that lack precise control of one or both of the number and the dimensions of the nanochannels and the nanopores fabricated. This lack of precise control limits the applications for which these synthetic nanostructures are useful.

Moreover, nanotubes have been used as nanochannels in nanofluidic devices. The nanotube is fabricated using a nanowire as a sacrificial core on which a nanotube sheath is formed or grown. Two techniques of forming the nanotubes have been reported that include an epitaxial casting technique and an oxidation and etching technique. The fabricated nanotubes are subsequently harvested from the fabrication substrate for later installation or deposition in or on a device, which is a tedious serial process that may be impractical for some applications.

Accordingly, it would be desirable to have a fabrication technique for nanochannels or nanopores that is conducive to a manufacturing environment of a variety of nano-scale devices that utilize such nanochannels or nanopores. Moreover, it would be desirable if such a fabrication technique was also cost-efficient. Such a technique would solve a long-standing need in the developing area of a “bottom-up” fabrication approach in nanotechnology.

### BRIEF SUMMARY

In some embodiments of the present invention, a nanochannel apparatus is provided. The nanochannel apparatus comprises a permanent support, and an array of nanochannels embedded in the permanent support. The array of nanochannels extends through a dimension of the support, such that distal ends of the nanochannels are exposed.

In some embodiments of the present invention, a nanofluidic system is provided. The nanofluidic system comprises a nanochannel apparatus that comprises an array of nanochannels embedded in a permanent support. The nanochannel array extends through a dimension of the permanent support, such that distal ends of the nanochannel apparatus are exposed. The nanofluidic system further comprises a fluidic interface adjacent to at least one of the distal ends of the nanochannel apparatus. The nanofluidic system further comprises a component interfaced to the nanochannel apparatus that facilitates one or more of analysis, detection and control of a fluid.

In some embodiments of the present invention, a method of fabricating a nanochannel apparatus is provided. The method of fabricating comprises encasing an array of nanowires in a support. The method of fabricating further comprises forming an array of nanochannels in situ through the support in locations of the nanowires, such. that distal ends of the nanochannels are exposed. The support is a permanent support for the nanochannels of the apparatus.

Certain embodiments of the present invention have other features that are one or more of in addition to and in lieu of the features described hereinabove. These and other features of some embodiments of the invention are detailed below with reference to the following drawings.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a perspective view of a nanochannel apparatus according to an embodiment of the present invention.

FIG. 2A illustrates a flow chart of a method of fabricating a nanochannel apparatus according to an embodiment of the present invention.

FIGS. 2B-2F illustrate perspective views of a nanochannel apparatus during fabrication using the method of FIG. 2A according to an embodiment of the present invention.

FIG. 3A illustrates a perspective view of a nanochannel apparatus according to another embodiment of the present invention.

FIG. 3B illustrates a cross-sectional view of the nanochannel apparatus of FIG. 3A.

FIG. 4A illustrates a flow chart of a method of fabricating a nanochannel apparatus according to another embodiment of the present invention.

FIG. 4B-4F illustrates perspective views of a nanochannel apparatus during fabrication using the method of FIG. 4A according to an embodiment of the present invention.

FIG. 4G illustrates a perspective view of the nanochannel apparatus of FIG. 4F according to another embodiment of the present invention.

FIG. 5A illustrates a side view of a nanofluidic sensor system according to an embodiment of the present invention.

FIG. 5B illustrates a side view of a nanofluidic sensor system according to another embodiment of the present invention.

FIG. 6 illustrates a side view of a nanofluidic transistor system according to an embodiment of the present invention.

### DETAILED DESCRIPTION

Some embodiments of the present invention are directed to a nanochannel formed from a nanowire grown to bridge between horizontally spaced apart vertical surfaces, wherein the nanowire is embedded in a support material and subsequently removed from the material. The vertical surface from which the horizontal nanowire grows is a (111) surface of a [110] oriented semiconductor crystal lattice. Other embodiments of the present invention are directed to a nanochannel formed from a nanowire grown vertically from a horizontal surface, wherein the nanowire is embedded in a support material and subsequently removed from the material. The horizontal surface from which the nanowire grows is a (111) surface of a [110] oriented semiconductor crystal lattice.

A semiconductor nanowire will grow preferentially nearly normal to the (111) surface. On a vertically oriented (111) surface, the nanowire will grow horizontally from, or essentially perpendicular to, the vertical (111) surface. On a horizontally oriented (111) surface, the nanowire will grow vertically from, or essentially perpendicular to, the horizontal (111) surface. The nanowire will grow substantially perpendicular to the (111) surface until the growth is intentionally stopped or until the nanowire contacts a facing surface that is respectively vertical or horizontal. By ‘essentially perpendicular’, ‘substantially perpendicular’ and ‘nearly normal’ it is meant that the nanowire will grow from the (111) surface predominantly in a direction to contact the respective facing surface. Once contacted, the nanowire will attach or connect to the respective facing surface.

The use of brackets ‘[ ]’ herein in conjunction with such numbers as ‘111’ and ‘110’ pertains to a direction or orientation of a crystal lattice and is intended to include directions ‘< >’ within its scope, for simplicity herein. The use of parenthesis ‘( )’ herein with respect to such numbers ‘111’ and ‘110’ pertains to a plane or a planar surface of a crystal lattice and is intended to include planes ‘{ }’ within its scope for simplicity herein. Such use is intended to follow common crystallographic nomenclature known in the art.

The materials useful for the various embodiments of the present invention include, but are not limited to, group IV, group IV-IV, group III-V and group II-VI materials, including compound semiconductor materials, from the Periodic Table of the Elements. For example and not by way of limitation, the nanowire may be made from a semiconductor including, but not limited to, any of silicon (Si), germanium (Ge), silicon carbide (SiC), gallium arsenide (GaAs), gallium nitride (GaN), gallium phosphide (GaP), indium phosphide (InP), indium arsenide (InAs), aluminum nitride (AlN), zinc oxide (ZnO), indium oxide (InO), indium tin oxide (ITO) and cadmium sulfide (CdS), for example, or a metal-semiconductor alloy. Numerous nanowire materials are known in the art. The scope of the various embodiments of the present invention is intended to include all such materials. In some embodiments, the nanowire is a single crystal structure, while in other embodiments, the nanowire may be an amorphous or multi-crystalline structure. A semiconductor nanowire can be grown such that one or more of length, diameter, shape, direction of growth, and position of the semiconductor nanowire are controlled in accordance with some embodiments of the present invention. Moreover, the nanowires may be grown from a substrate used for semiconductor device fabrication.

The substrate material comprises one or more of the semiconductor materials listed above, and may include, but is not limited to, the list of nanowire materials from above. For example, a silicon nanowire will grow in a direction that is nearly normal to a (111) plane of a crystal lattice of, for example, a semiconductor substrate or wafer made of Si or GaAs. Moreover, the support material described below comprises one or more of the semiconductor materials listed above, an insulator material and a metal. For example, the support material may be an oxide or a nitride of the above materials including, but not limited to, silicon dioxide, silicon nitride and aluminum oxide. For the purposes of the embodiments herein, the support material is intended to be a permanent support for the nanochannel, while the substrate may provide either temporary or permanent support to the apparatus.

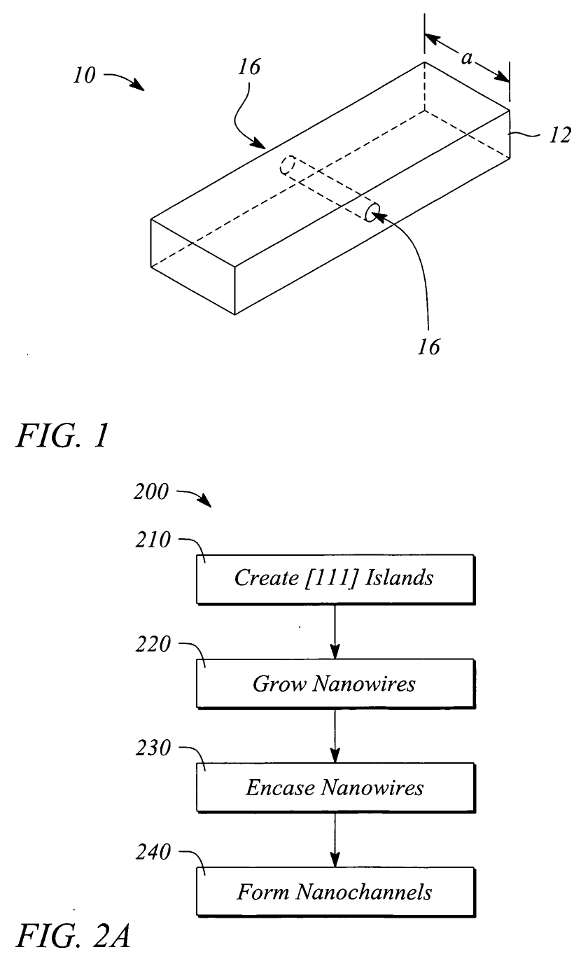

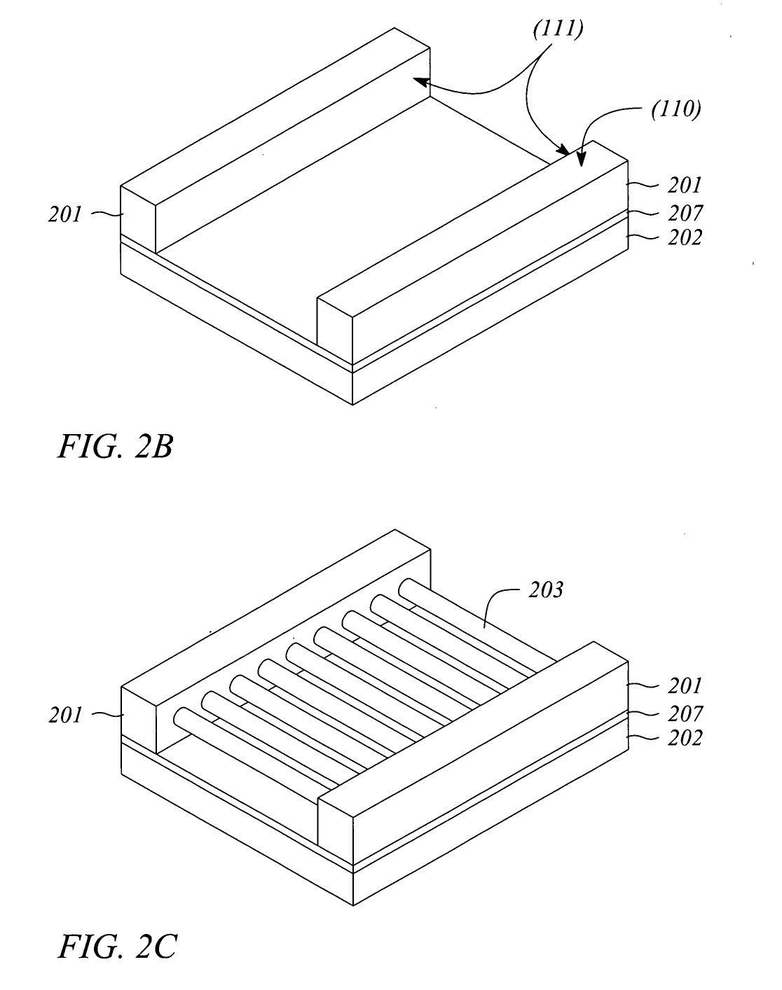

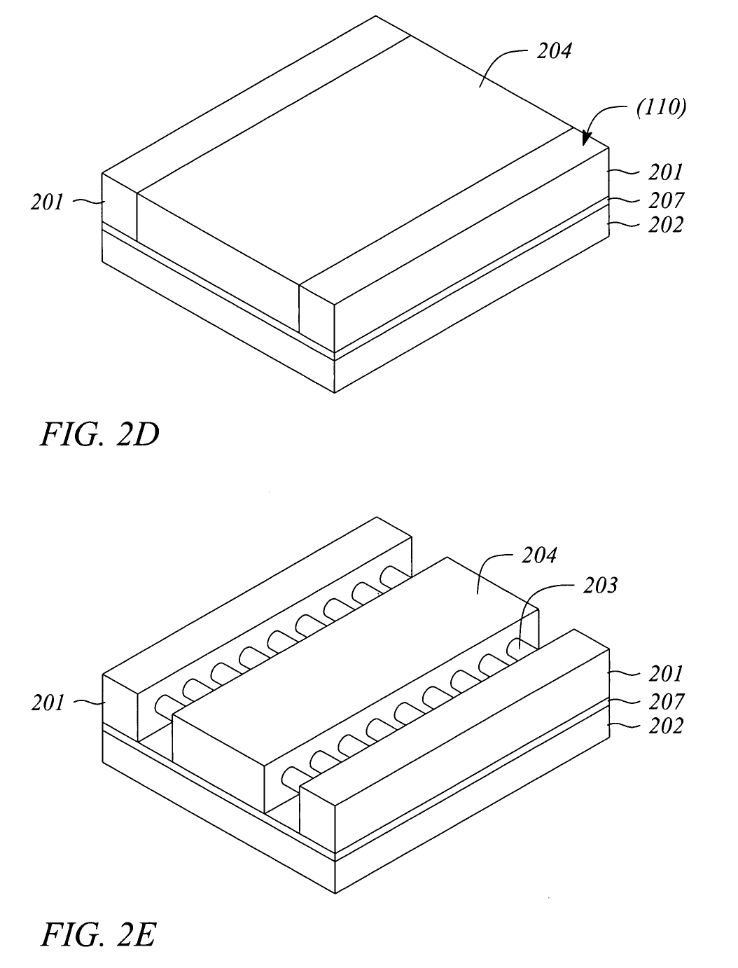

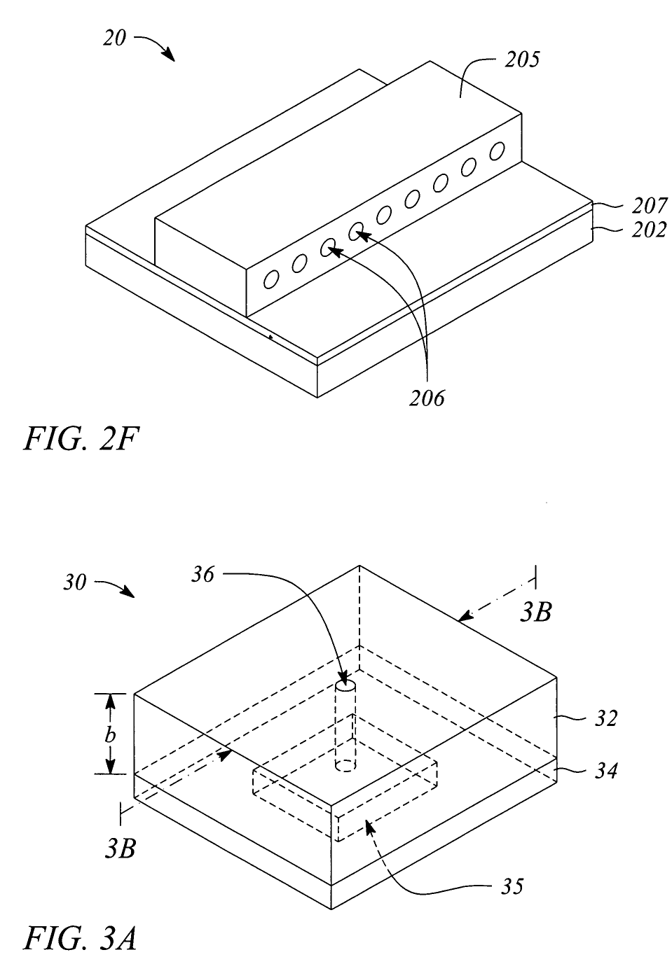

In some embodiments of the present invention, a nanochannel apparatus 10 is provided. FIG. 1 illustrates a perspective view of the nanochannel apparatus 10 according to an embodiment of the present invention. The nanochannel apparatus 10 comprises a support or block 12 having an array of nano-scale size channels or pores 16 through a dimension of the support 12. Hereafter, the term ‘nanochannel’ will be used to interchangeably to refer to a ‘channel’ or a ‘pore’ having a nano-scale dimension, for simplicity and without limitation. The nanochannels of the array each has distal ends that are open or exposed. Moreover, the term ‘array’ used herein defines a quantity equal to or greater than two, i.e., a plurality. FIG. 1 illustrates only one nanochannel 16 of the array, for the purpose of simplicity herein and not by way of limitation. The nanochannel 16 has a predominant or principal dimension a (i.e., length) and extends laterally through the support 12. In some embodiments, the nanochannel apparatus 10 further comprises a substrate adjacent to the support 12. In these embodiments, the nanochannel array is horizontally oriented or essentially parallel to a horizontal plane of the substrate. Embodiments of the nanochannel apparatus that further include a substrate are described below with respect to FIGS. 2A-2F.

According to another embodiment of the present invention, a method of fabricating a nanochannel apparatus is provided. The method of fabricating comprises encasing a plurality of nanowires in a support on a substrate; and forming an array of nanochannels in the support in the locations of the nanowires, such that the nanochannels of the array have distal open ends. The support is a permanent support for the nanochannels of the apparatus, while the substrate is either temporary or permanent, depending on the embodiment. Moreover, the nanowires are grown in situ on the substrate before being encased, and the nanochannels are formed in situ in the support. The nanochannels correspond in size to that of the encased nanowires. The resultant nanochannel apparatus is an in situ nanochannel apparatus.

In some embodiments, a method 200 of fabricating a nanochannel apparatus having an array of horizontal-oriented nanochannels is provided. FIG. 2A illustrates a flow chart of the method 200 of fabricating a nanochannel apparatus according to an embodiment of the present invention. FIGS. 2B-2F illustrate perspective views of a nanochannel apparatus 20 during fabrication according to the method 200. The method 200 of fabricating comprises creating 210 spaced apart parallel islands 201 of a first layer of a material supported by a substrate 202. In some embodiments, the substrate 202 is a semiconductor material having an insulator material layer 207 on the substrate 202 surface. The substrate 202, 207 materials include, but are not limited to, a silicon wafer with a layer of either silicon dioxide or silicon nitride on the surface, for example and not by way of limitation. The first layer is a crystalline material polished in a [110] direction such that the horizontal surface is a (110) plane. For example, the first layer may be a silicon layer having a [110] crystal orientation. At least one of the created islands 201 has a vertical (111) planar surface that faces a vertical surface of the other created island 201, wherein the (111) surface is vertical relative to the (110) horizontal planar surface.

As illustrated in FIG. 2B, both of the created islands 201 have a vertical surface that is (111) planar surface and that faces the other vertical surface in some embodiments. The created 210 islands are essentially parallel vertical walls of a trench when viewed from an end or in cross-section. The parallel islands 201 having vertical (111) surfaces may be created 210 using the techniques described in co-pending U.S. patent application, Ser. No. 10/738,176, filed Dec. 17, 2003, U.S. Publication 2005/0133476-A1, published Jun. 23, 2005, incorporated herein by reference in its entirety. For example, the first layer of material may be one or more of mechanically cut, laser cut, wet chemical etched and dry etched, for example and not by way of limitation, along (111) lattice planes down to the substrate 202 surface or down to a insulator layer 207 on the substrate 202 surface to create a trench that has vertical sidewalls. An internal surface of the vertical sidewalls are aligned with vertical (111) lattice planes of the first layer. The vertical sidewalls of the trench are the parallel islands 201.

The method 200 of fabricating further comprises growing 220 nanowires from the vertical (111) surface of a first island of the created islands 201 to a second island of the created islands 201. Since a nanowire preferentially grows nearly normal to a (111) surface, the nanowire will grow preferentially horizontal to the vertical (111) surface. FIG. 2C illustrates an array of such nanowires 203, for example, grown 220 preferentially horizontal to the vertical (111) surface of the first island 201 to laterally bridge across the trench and contact the other (or second) spaced apart island 201. The grown nanowires 203 are effectively suspended between the spaced apart, parallel islands 201.

There are many techniques known in the art for growing nanowires that may be used in this embodiment. In particular, nanowires are grown in the location where they will be used to form a nanochannel in the apparatus (i.e., in situ). Nanowires may be ‘grown’ using methods such as, but not limited to, vapor-liquid-solid (VLS), vapor-solid-solid (VSS), solution-liquid-solid (SLS), which are known in the art, using a catalyst particle. The growth method may be referred to as catalyzed growth or in some embodiments, metal-catalyzed growth. However, any of the in situ growth methods may be substituted for the metal-catalyzed growth and still be within the scope of the embodiments described herein. Metal-catalyzed growth is described in more detail in the co-pending U.S. patent application, Ser. No. 10/738,176, cited and incorporated by reference supra.

For example, in some embodiments, a catalyst material is deposited on the vertical (111) surface of one or both of the parallel islands 201. The catalyst material may be annealed into activated catalyst (i.e., a nanoparticle catalyst) or may be deposited in an activated form. The catalyst material may include, but is not limited to, gold (Au), nickel (Ni), titanium (Ti), iron (Fe), cobalt (Co), and gallium (Ga), and respective alloys thereof. Other catalyst materials may include, but are not limited to, nonmetals, such as SiOₓ, where x ranges from about 1 to less than 2, for example. The catalyst materials used for growing a Si nanowire, for example, include, but are not limited to, Ti, Au, TiSi₂ alloy and Au—Si alloy.

The activated (111) surface is exposed to a controlled temperature, pressure and a gas containing a material of the nanowire to be grown. In some embodiments, the activated vertical (111) surface is exposed to the gas in the reactor chamber of the material deposition system. As such, the temperature and pressure are regulated, and the gas or a gas mixture is introduced and controlled during nanowire growth 220. In some embodiments, the activated (111) surface is exposed to the gas in the reactor chamber under conditions at which the uncatalyzed (i.e., normal) deposition rate is low. The catalyst accelerates the decomposition of the gas, allowing a high ratio of catalyzed-to-normal growth. Material deposition systems including, but not limited to, chemical vapor deposition (CVD) systems, metal organic vapor phase epitaxy (MOVPE) systems, molecular beam epitaxy (MBE) systems, plasma-enhanced CVD (PECVD) systems, resistance-heated-furnace diffusion/annealing systems, and rapid thermal processing (RTP) systems may be employed for the nanowire growth 220, for example. For a Si nanowire, growth 220 using a CVD system and a process that employs a Si-containing gas including, but not limited to, a gas mixture of silane (SiH₄) and hydrogen chloride (HCl), a gas of dichlorosilane (SiH₂Cl₂), or a silicon tetrachloride (SiCl₄) vapor in a hydrogen (H₂) ambient may be used, for example and not by way of limitation.

The nanowire grows 220 in a columnar shape from the vertical (111) surface adjacent to the activated catalyst particle. A free end of the columnar-shaped growing nanowire contains the activated catalyst particle. The nanowire continues to grow in the environment described above until the free end of the nanowire 203 contacts the vertical surface of the other parallel island 201. In some embodiments, contact of the free end is accompanied by attachment to the vertical surface of the other island 201. The grown nanowires 203 are effectively suspended to bridge across the trench.

The method 200 of fabricating further comprises encasing or enveloping 230 the laterally bridging nanowires 203 in a second layer 204 of material. The second layer 204 may fill the trench formed by the spaced apart islands 201. FIG. 2D illustrates the second layer 204 between the islands 201 that encases or envelops 230 the array of nanowires 203. The material of the second layer 204 is different from the materials of the nanowire 203 and the islands 201 (i.e., the first layer) and is intended as a permanent support or block for the subsequently formed nanochannels. Various materials may be used for the second layer 204 including, but not limited to, silicon dioxide, silicon nitride, aluminum oxide, aluminum nitride, a polymeric material, and a metal.

Encasing 230 the nanowires 203 comprises depositing the material of the second layer 204 to completely surround the horizontally suspended nanowires 203. The material of the second layer 204 is deposited using any of the deposition or growth techniques known in the art including, but not limited to, one or more of chemical vapor deposition (CVD) and plasma enhanced CVD (PECVD), for example and not by way of limitation, and may depend in part on the material chosen for the second layer 204. Moreover, angled deposition may be used to facilitate the material surrounding the nanowires 203, for example and not by way of limitation.

In some embodiments, encasing 230 the nanowires 203 further comprises removing excess deposited material of the second layer 204 to expose the horizontal (110) planar surface of the islands 201 and form the second layer 204. FIG. 2D further illustrates that horizontal (110) planar surfaces of the islands 201 are exposed. Removing excess second material includes, but is not limited to, one or more of chemical etching, mechanical polishing, chemical mechanical planarization (CMP) and lithography. In some embodiments, encasing 230 further comprises masking the islands 201 and a portion of the nanowires 203 that is adjacent to at least one of the islands 201 before the material of the second layer 204 is deposited, and subsequently removing the mask to expose the islands 201 and the nanowire portions after the second layer 204 material is deposited.

The method 200 of fabricating further comprises forming 240 nanochannels in a permanent support of the nanochannel apparatus 20. In some embodiments, forming 240 nanochannels comprises removing 240 the nanowires 203 from the second layer 204 while leaving the second layer 204 or a majority thereof permanently intact. In some embodiments, forming 240 nanochannels further comprises removing 240 the islands 201 either simultaneously or sequentially with the removal of the nanowires. Moreover in some embodiments, forming 240 nanochannels further comprises removing a section of the second layer 204 at an interface immediately adjacent to one or both of the islands 201 to expose a portion of the nanowires 203 from the section. FIG. 2E illustrates the apparatus with the section of the second layer 204 removed and the nanowire 203 portions exposed according to an embodiment.

A section of the second layer 204 may be removed using a variety of techniques known in the art including, but not limited to, one or more of dry etching, for example, reactive ion etching (RIE) or ion milling, wet chemical etching, and lithography, and depends on the material used for the second layer 204. In some embodiments, the technique selectively removes the section of the second layer 204 but not the adjacent islands 201 or the nanowires 203. As such, one or more other techniques that are selective to the removal of the nanowires 203 is used to further remove the nanowires 203, while the islands 201 may be optionally removed also, depending on the embodiment.

In some embodiments, the islands 201 and the nanowires 203 are removed with selective etching, such as using one or more of XeF₂ dry chemical etching and a selective wet etching technique, for example and not by way of limitation, and depends on the materials of the islands 201 and of the nanowires 203. The nanowires 203 are removed from the support layer 204 selectively, such that nanochannels 206 in the support layer 204 are created 240 where the horizontally suspended nanowires 203 are removed. FIG. 2F illustrates the resultant nanochannel apparatus 20 with the nanowires 203 and the parallel islands 201 removed 240. Respective nanochannels 206 extending laterally through the second layer 204 take the place of (i.e., remains as a result of the removal of) the array of nanowires 203. The second layer 204 forms the permanent support 205 for the laterally or horizontally extending nanochannels 206 of the nanochannel apparatus 20.

The nanochannel apparatus 20 illustrated in FIG. 2F is similar to the nanochannel apparatus 10 illustrated in FIG. 1, except that the nanochannel apparatus 20 of FIG. 2F includes the substrate 202 and illustrates the array of the nanochannels 206. In some embodiments, the nanochannel apparatus 10 is fabricated using the method 200 described above. As such, the method 200 may further comprise separating the support 205 from the substrate 202 (and insulator layer 207, when present), such as by using one or more of the etching techniques mentioned above, to remove the substrate 202, 207 from the support 205.

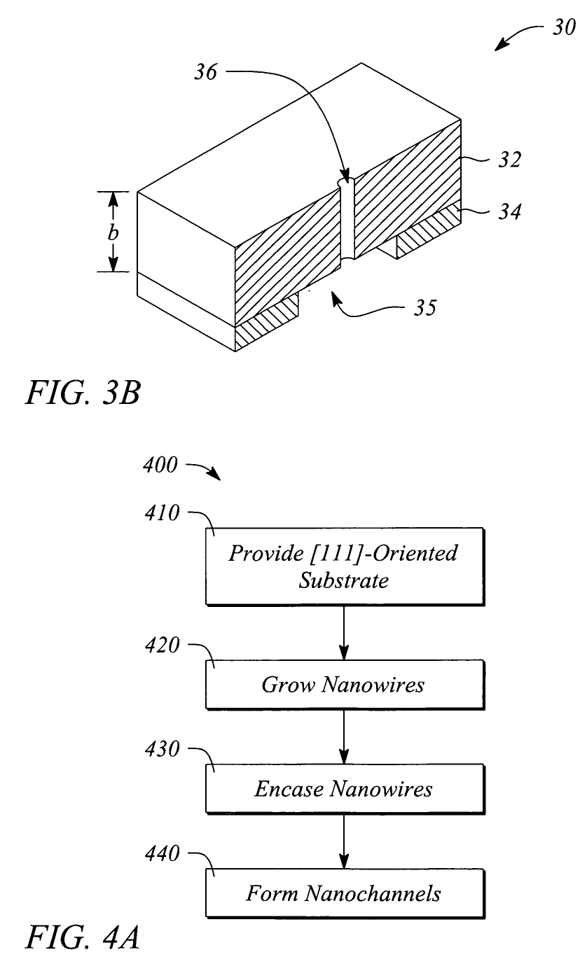

In another embodiment of the present invention, a nanochannel apparatus 30 is provided. FIGS. 3A and 3B illustrate perspective views of the nanochannel apparatus 30 according to an embodiment of the present invention. FIG. 3B is a perspective cross sectional view of the nanochannel apparatus 30 along line B-B in FIG. 3A. The nanochannel apparatus 30 comprises a support 32 having an array of nanochannels 36 that extends through a dimension of the support 32. FIGS. 3A and 3B illustrate only one of the nanochannels 36 of the array for simplicity and not by way of limitation. In FIGS. 3A and 3B, the nanochannel 36 has a predominant or principal dimension b (i.e., length) that extends through an equivalent dimension b (i.e., height or thickness) of the support 32, such that the nanochannel 36 is vertically oriented or parallel to the dimension b of the support 32. In some embodiments, the nanochannel apparatus 30 further comprises a substrate 34 having an opening 35. The substrate 34 has a horizontal (111) planar surface that is adjacent to the support 32. In these embodiments, the vertically oriented nanochannel 36 is essentially perpendicular to the horizontal surface plane of the substrate 34. The nanochannel 36 extends vertically relative to the substrate plane in a location coaxial with the opening 35.

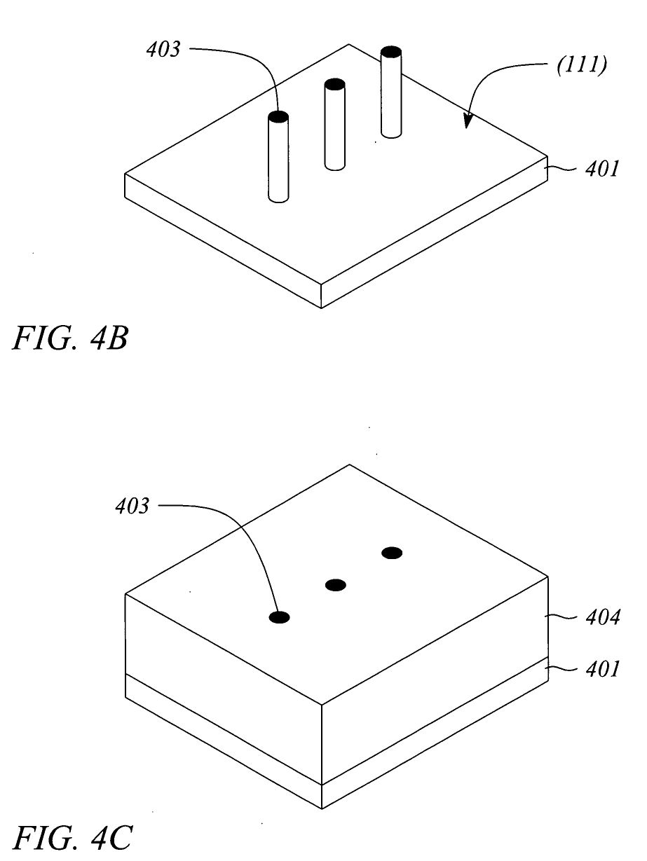

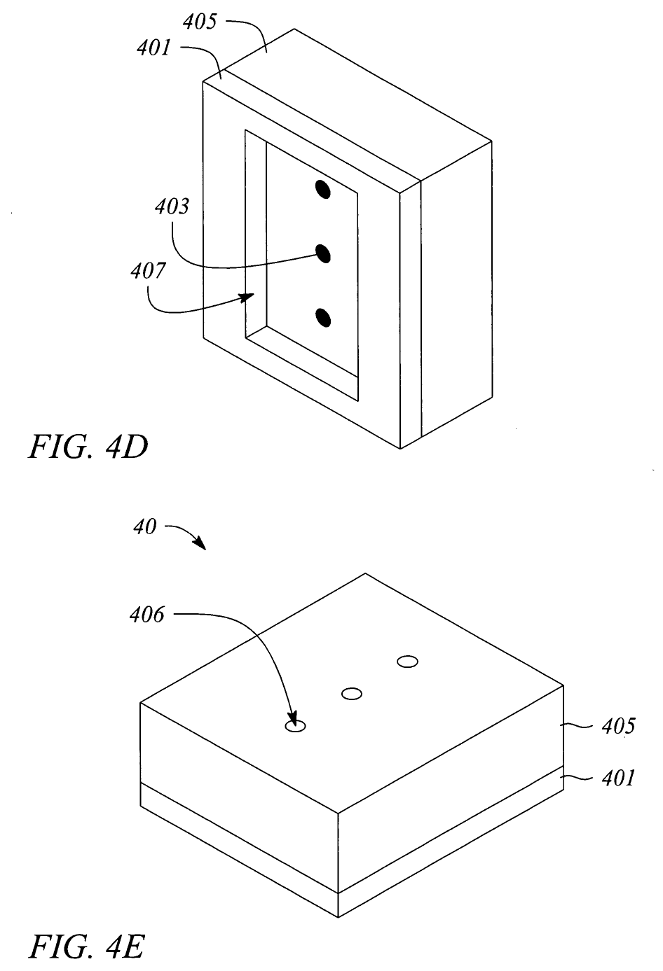

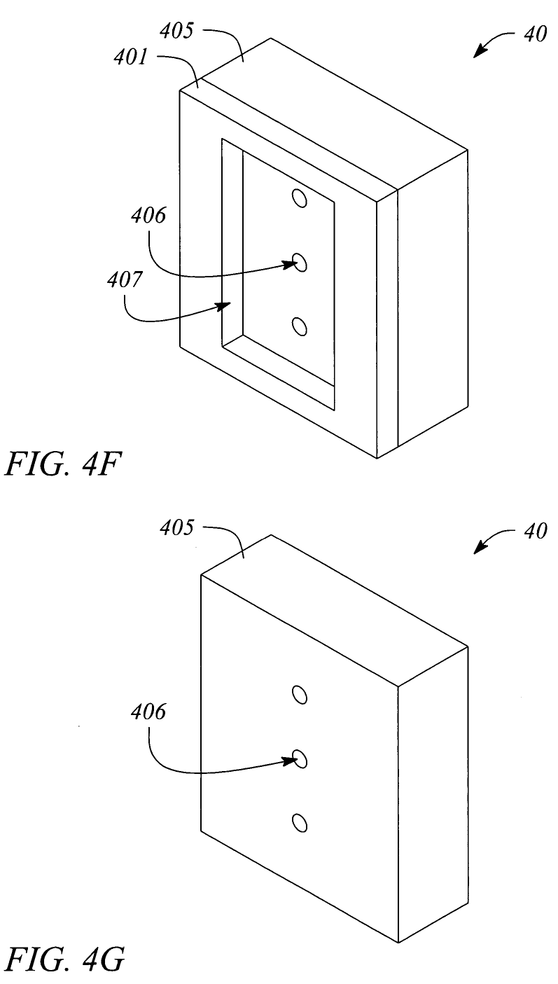

In another embodiment of the present invention, a method 400 of fabricating a nanochannel apparatus having an array of vertical-oriented nanochannels is provided. FIG. 4A illustrates a flow chart of the method 400 of fabricating a nanochannel apparatus according to an embodiment of the present invention. FIGS. 4B-4F illustrate perspective views of a nanochannel apparatus 40 during fabrication according to the method 400. The method 400 of fabricating comprises providing 410 a substrate 401 having a [111]-oriented crystal lattice. In some embodiments, the substrate 401 is polished in a [111] direction. The provided substrate 401 has an exposed surface that is a horizontal (111) lattice plane.

The method 400 of fabricating further comprises growing 420 an array of nanowires from the horizontal (111) surface. Since a nanowire preferentially grows nearly normal to a (111) surface, the nanowires will grow preferentially vertical to the horizontal (111) surface. FIG. 4B illustrates the array of nanowires 403, for example, grown 420 preferentially vertical to the horizontal (111) surface of the substrate 401. The nanowires 403 are grown using any of the growth techniques described or referenced above for the method 200 of fabricating. Moreover, vertical growth of nanowires from horizontal (111) planar surfaces is described in more detail in co-pending U.S. patent application, Ser. No. 10/982,051, filed Nov. 5, 2004, incorporated by reference herein in its entirety.

A nucleating catalyst material is deposited on the (111) surface in a very thin layer and annealed in a controlled environment (i.e., chamber) to form isolated nanoparticles of the catalyst material. Alternatively, when the nanoparticle catalyst is directly deposited, annealing may be optional. The catalyst material may be lithographically patterned using techniques known in the art to define target locations of the catalyst material on the horizontal (111) surface of the substrate 401 from which nanowires 403 are to be grown 420. As described above for the method 200, a nanowire material-containing gas is introduced into the controlled environment. The nanoparticle catalyst accelerates decomposition of the gas, such that atoms of the nanowire material precipitate between the nanoparticle catalyst and the horizontal (111) surface to initiate nanowire growth 420.

The nanowire 403 will grow 420 from under the nanoparticle on the (111) horizontal surface in columnar form, taking the nanoparticle with it at its tip or free end. The nanowires 403 will continue to grow until growth is terminated, such as by terminating the growth environment in the chamber or removing the substrate 401 from the chamber, for example.

The method 400 of fabricating further comprises encasing or enveloping 430 the grown nanowires 403 in a support layer 404 of material. The support layer 404 may fully encase the nanowires 403 or in some embodiments, may encase a portion of a length of the nanowires 403, such that the free ends of the nanowires 403 are exposed or otherwise not encased 430 in the material of the support layer 404. FIG. 4C illustrates the support layer 404 that encases or embeds 430 the array of nanowires 403. The material of the support layer 404 is different from the materials of the nanowire 403 and the substrate 401 and is intended as a permanent support or block 405 for the subsequently formed nanochannels 406. Any of the materials provided above for the support material or the second layer 204 of the method 200 of fabricating may be used for the material of the support layer 404, for example. Encasing 430 the nanowires 403 comprises depositing the material of the support layer 404 to completely surround the nanowires 403. The material of the support layer 404 is deposited using any of the deposition or growth techniques described above for the method 200 of fabricating, and may depend in part on the material chosen for the support layer 404.

In some embodiments, encasing 430 the nanowires 403 further comprises removing excess deposited material of the support layer 404 to expose the free ends of the vertically grown nanowires 403. FIG. 4C further illustrates that the free ends of the nanowires 403 are exposed. Removing excess material of the support layer 404 includes, but is not limited to, one or more of chemical etching, mechanical polishing, chemical mechanical planarization (CMP).

The method 400 of fabricating further comprises forming 440 an array of nanochannels in the support layer 404 of the apparatus 40. Forming 440 the nanochannels comprises removing 440 at least a section of the substrate 401 and removing the nanowires 403 from the support layer 404 while leaving the support layer 404 permanently intact. FIG. 4D illustrates the apparatus with the section of the substrate 401 removed to expose the nanowires 403 in an opening 407 created in the substrate 401 by the removed section that is coaxial with the array of nanowires 403.

A section of the substrate 401 may be removed using a variety of techniques known in the art including, but not limited to, one or more of dry etching, for example reactive ion etching (RIE) or ion milling, wet chemical etching, and lithography, and depends on the material used for the substrate. The technique or techniques used will selectively remove the section of the substrate 401, and optionally, will remove the material of the nanowires 403, depending on the embodiment, but will not remove the material of the support layer 404. In some embodiments, the technique(s) used for the removal of the substrate 401 section selectively does not remove the nanowires 403. Where the nanowires 403 are not removed with the section of the substrate 401, another of the above described techniques may be used to selectively remove the nanowires 403. In some embodiments, the entire substrate 401 is removed instead of a section thereof that is coaxial with the nanowires 403. In other embodiments, the section of the substrate 401 is removed, followed by the removal of the nanowires 403, and then the removal of a remainder of the substrate 401.

The nanowires 403 are removed from the support layer 404 selectively, such that an array of nanochannels 406 in a support or block 405 are created 440 where the nanowires 403 are removed. FIG. 4E illustrates the resultant nanochannel apparatus 40 with the nanowires 403 removed 440. FIG. 4F illustrates a perspective view of an opposite end of the resultant nanochannel apparatus 40 that illustrates the opening 407 formed as a result of removing a section of the substrate 401 that is coaxial with the formed nanochannels 406. FIG. 4G illustrates a perspective view of the nanochannel apparatus 40, according to another embodiment, that has the substrate 401 completely removed, such that the nanochannel apparatus 40 essentially is the nanochannel support block 405.

The nanochannel apparatus 40 illustrated in FIGS. 4E and 4F is similar to the nanochannel apparatus 30 illustrated in FIGS. 3A and 3B, except that the nanochannel apparatus 40 has the array of nanochannels 406 illustrated. In some embodiments, the nanochannel apparatus 30 is fabricated using the method 400 described above. Moreover, while not illustrated, in some embodiments, the support layer 404 may envelop the nanowires 403 but not cover one or more portions of the substrate 401 surface that do not include the grown nanowires 403. As a result, some embodiments of the nanochannel apparatus 40 may have exposed horizontal (111) surfaces of the substrate 401 adjacent to the support block 405 having nanochannels 406. The embodiment illustrated in FIG. 2F may be representative of these features. For example, the nanochannel apparatus 40 having exposed substrate surfaces is similar to that depicted for the nanochannel apparatus 20 in FIG. 2F, except that vertically extended nanochannels 406 coaxial with an opening 404 in the substrate would replace the illustrated horizontally extended nanochannels 206.

According to some embodiments of the present invention, a diameter of the nanochannels 16, 206, 36, 406 may be controlled or adjusted in the respective nanochannel apparatuses 10, 20, 30, 40. For example, in some embodiments of the methods 200, 400 of fabricating a nanochannel apparatus, a thermal oxide may be grown on the nanowires 203, 403, such that a diameter of the nanowires 203, 403 is reduced by the thickness of the thermal oxide layer. During forming 240, 440 nanochannels, the reduced-diameter nanowires 203, 403 (or core nanowire materials) are removed, such that the resultant nanochannels 206, 406 are actually narrower in diameter (by approximately the thickness of the thermal oxide layer) than they would have been without thermal oxidation of the nanowires 203, 403. In an example, silicon nanowires having a diameter of approximately 5 nanometers (nm) may be thermally oxidized prior to forming 240, 440 nanochannels to achieve a resultant nanochannel diameter of approximately 2 nm to approximately 3 nm.

In some embodiments, the nanochannel apparatus 10, 20, 30, 40 may be further processed to include one or more components and structures to provide a variety of nanofluidic devices or systems. For example, one or more of the nanochannels 206, 406 of the apparatus 20, 40 may be interfaced to one or more fluidic components and structures formed on the surface of the substrate 202, 401 for one or more of holding, processing and sensing fluids that travel through the one or more nanochannels 206, 406. A fluid is defined to include one or both of a liquid and a vapor herein. In some embodiments of the present invention, any of the nanochannel apparatuses 10, 20, 30, 40 described above may be used in a variety of miniaturized systems for analysis, detection and control.

In some embodiments of the present invention, a nanofluidic system is provided. The nanofluidic system comprises a nanochannel apparatus 10, 20, 30 40; a fluidic interface adjacent to at least one open end of the nanochannel apparatus 10, 20, 30 40; and a component interfaced to the nanochannel apparatus 10, 20, 30 40. The component is defined herein as a structure or element that facilitates one or more of analysis, detection and control. In some embodiments, the component comprises one or more of an electrode and a sensor. The electrode comprises one or more of a gate electrode, a source electrode and a drain electrode, for example and not by way of limitation. The sensor comprises one or more detectors, nano-detectors and nano- emitters. The sensor includes, but is not limited to, one or more of a nanowire-based sensor, a single electron transistor, an optical detector, and an optoelectronic structure, such as a vertical cavity surface emitting laser (VCSEL), including a nano-VCSEL, for example and not by way of limitation. See, U.S. Pat. No. 6,815,706 B2, issued Nov. 9, 2002; co-pending U.S. patent application Ser. No. 10/982,051, cited supra; and co-pending U.S. patent application Ser. No. 11/084,886, filed Mar. 21, 2005, incorporated herein by reference in their entireties, for some examples of a nano-detector or a nano-device useful in various embodiments of a nanofluidic system according to the present invention. In some embodiments, the nanochannel apparatus 10, 20, 30, 40 may be integrated with a component, as described above, and optionally other devices to form miniaturized systems for fluidic processing of biological materials, such as DNA.

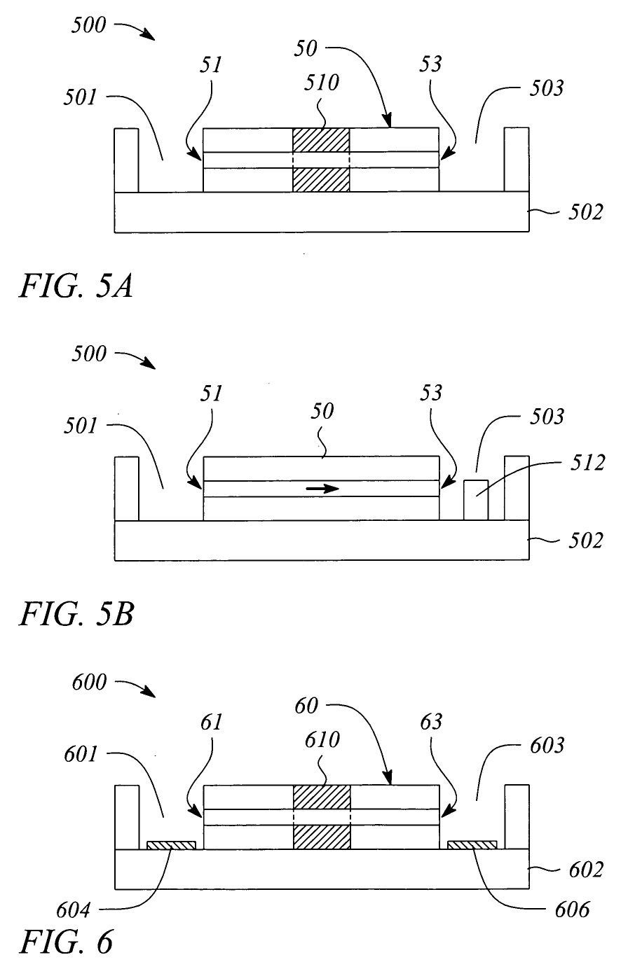

FIGS. 5A and 5B illustrates a nanofluidic sensor system 500 according to embodiments of the present invention. The nanofluidic sensor system 500 comprises a nanochannel apparatus 50; a fluidic interface 501 at a first open end 51 of the nanochannel apparatus 50 and a sensor 510 interfaced to the nanochannel apparatus 50. The nanochannel apparatus 50 is similar to any of the nanochannel apparatus embodiments 10, 20, 30, 40 described above. In some embodiments, the nanofluidic sensor system 500 further comprises another fluidic interface 503 at a second open end 53 that is distal to the first open end 51 of the nanochannel apparatus 50. In some embodiments, the nanofluidic sensor system 500 is supported by a substrate 502.

As illustrated in FIG. 5A, the sensor 510 is incorporated into or embedded in the nanochannel apparatus 50 of the nanofluidic sensor system 500 in some embodiments. By ‘incorporated into’ or ‘embedded in’ it is meant that the component forms an integral portion of at least one of the nanochannels of the array. Moreover, the fluidic interfaces 501, 503 illustrated in FIG. 5A are exemplary fluid reservoirs 501, 503. In other embodiments, such fluidic interfaces include, but are not limited to, one or more of a conduit, a valve, a via, and another nanochannel apparatus, for example, and not by way of limitation. As such, when a fluid is moved from a first fluid interface 501 to a second fluid interface 503, the fluid passes through or by the sensor 510 embedded in the nanochannel apparatus 50, such that one or more characteristics of the fluid may be analyzed or detected using the sensor 510. In some embodiments, the sensor 510 or another sensor, such as any of those mentioned above, may be located adjacent to one or both of the open ends 51, 53 in addition to or in lieu of that illustrated in FIG. 5A. See, for example, co-pending U.S. patent application Ser. No. 11/145,038, filed Jun. 3, 2005, incorporated herein by reference in its entirety.

In another embodiment, the nanofluidic sensor system 500 comprises a sensor 512 interfaced with an open end 51, 53 of the nanochannel apparatus 50, as illustrated in FIG. 5B. In particular, the sensor 512 is located or formed on the substrate 502 within one or both of the fluidic interfaces 501, 503. FIG. 5B illustrates the sensor 512 within fluidic reservoir 503 by way of example and not by way of limitation. While not illustrated in FIG. 5B, the sensor 512 may be in addition to rather than in lieu of the sensor 510 that is embedded in the nanochannel apparatus 50 of FIG. 5A, depending on the embodiment. Moreover, a sensor in addition to or in lieu of the sensor 512 may be located in the reservoir 501, depending on the embodiment. Assuming fluid flow is primarily in the direction of the horizontal arrow illustrated in FIG. 5B, a terminally located sensor 512 in the nanofluidic sensor system 500 can detect one or both of a substance and characteristics about the substance as the substance exits the nanochannel apparatus 50 and enters the reservoir 503.

In some embodiments, the embedded sensor 510 is replaced by an embedded electrode, such as a metal or semiconductor gate of a nanofluidic transistor. FIG. 6 illustrates a nanofluidic transistor 600 according to another embodiment of the present invention. The nanofluidic transistor 600 comprises a nanochannel apparatus 60, such as that described above for the nanochannel apparatus 50 in FIG. 5, that includes a first electrode 610 embedded in the nanochannel apparatus 60. The nanofluidic transistor 600 further comprises a first fluidic interface 601, and a second fluidic interface 603, such as reservoirs 601, 603, for example and not by way of limitation, associated with distal open ends 61, 63 of the nanochannel apparatus 60 in much the same way as that described above for the nanofluidic sensor system 500 in FIG. 5. The nanofluidic transistor 600 further comprises a source or second electrode 604 interfaced with the first reservoir 601 and a drain or third electrode 606 interfaced with the second reservoir 603. The nanofluidic transistor 600 controls the flow of fluid through the nanochannel apparatus 60 in the same way as a switch, for example and not by way of limitation. The nanofluidic transistor 600 may further comprise a substrate 602 that supports the nanofluidic transistor 600.

The sensors 510, 512 and the electrodes 604, 606 and 610 may be fabricated using standard semiconductor processing and materials. For example, the sensor 510 or the electrode 610 may be incorporated into the nanochannel apparatus 50, 60 during the fabrication of the nanochannel apparatus. Referring back to the method 200 of fabricating the nanochannel apparatus 20 in FIG. 2A and FIG. 2D, for example, after the nanowires 203 are grown 230 and embedded in the support material 204, one or both of the sensor 510 and the electrode 610 may be added. In some embodiments, another section of the support material 204 may be removed at a respective location along the horizontal length a of the grown nanowire 203 where the potential sensor 510 or electrode 610 is to be located. Then, the sensor 510 or the electrode 610 may be formed in the respective location using semiconductor processing techniques and materials known in the art. These steps may be performed prior to when a portion of the support material 204 is removed as illustrated in FIG. 2E and described above for the fabrication of the nanochannel apparatus 20.

In another example, referring back to the method 400 of fabricating the nanochannel apparatus 40 in FIG. 4A and FIG. 4B, encasing 430 the grown 420 nanowires 403 in the support material 404 may comprise encasing a first portion of the vertical length b of the nanowire 403 in the support material 404, then depositing material(s) used to form one or both of the sensor 510 and the electrode 610 in a second portion at a respective location along the vertical length b of the nanowires 403 and then, encasing a remaining portion of the vertical length b of the nanowires 403 in the support material 404, as described above for the nanochannel apparatus 40.

Any of the embodiments of the nanofluidic system 500, 600 illustrated in FIGS. 5A, 5B and 6 may further comprise a cover or lid that encloses at least the fluidic interfaces 501, 503, 601, 603. For example and not by way of limitation, the cover or lid may be deposited to extend over the entire system 500, 600, such that the respective sensor 510, 512 and electrodes 610, 604, 606 remain accessible. The cover or lid may include a layer of a material compatible with the use of the nanofluidic system.

Thus, there have been described various embodiments of a nanochannel apparatus, a method of fabricating a nanochannel apparatus and a nanofluidic system. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A nanochannel apparatus comprising:
a permanent support; and
an array of nanochannels embedded in the permanent support, the array extending through a dimension of the support, such that distal ends of the nanochannels are exposed.

2. The nanochannel apparatus of claim 1, wherein the array of nanochannels extends through the dimension of the support, such that the dimension of the support equals a length of the nanochannels of the array.

3. The nanochannel apparatus of claim 1, further comprising a substrate adjacent to the support, wherein the array of nanochannels extends either horizontally or vertically relative to a horizontal plane of the substrate through the dimension of the support.

4. The nanochannel apparatus of claim 3, wherein a surface of the substrate that is adjacent to the support is a horizontal (111) lattice plane.

5. The nanochannel apparatus of claim 3, wherein a surface of the substrate adjacent to the support comprises an insulator layer of a semiconductor-on-insulator wafer.

6. The nanochannel apparatus of claim 3, wherein the substrate has an opening coaxial with the array of nanochannels that exposes a distal end of each of the nanochannels.

7. The nanochannel apparatus of claim 3, wherein a material of the support is different from a material of the substrate.

8. The nanochannel apparatus of claim 1, further comprising a component embedded in the support adjacent to and at a location along a length of one or more of the nanochannels of the array.

9. The nanochannel apparatus of claim 8, wherein the component comprises one or more of a nano-detector and an electrode.

10. The nanochannel apparatus of claim 1 used in a nanofluidic system.

11. A nanofluidic system comprising:
a nanochannel apparatus that comprises an array of nanochannels embedded in a permanent support, the nanochannel array extending through a dimension of the permanent support, such that distal ends of the nanochannel apparatus are exposed;
a fluidic interface adjacent to at least one of the distal ends of the nanochannel apparatus; and
a component interfaced to the nanochannel apparatus that facilitates one or more of analysis, detection and control of a fluid.

12. The nanofluidic system of claim 11, wherein the component is embedded in the permanent support adjacent to and at a location along a length of at least one the nanochannels of the array.

13. The nanofluidic system of claim 11, further comprising a substrate adjacent to the nanochannel apparatus and the fluidic interface.

14. The nanofluidic system of claim 13, wherein the component is located one or both of on a surface of the substrate adjacent to one or both of the distal ends of the nanochannel apparatus and embedded in the permanent support adjacent to and at a location along a length of the nanochannel array.

15. The nanofluidic system of claim 13, wherein the nanochannel array extends vertically relative to a horizontal plane of the substrate, the substrate having an opening coaxial with the array of nanochannels that exposes the distal end of the nanochannel apparatus that is adjacent to the substrate opening.

16. The nanofluidic system of claim 13, wherein the nanochannel array extends horizontally relative to a horizontal plane of the substrate.

17. The nanofluidic system of claim 11, wherein the fluidic interface comprises one or more of a reservoir, a conduit, a via, a valve, and another nanochannel apparatus.

18. The nanofluidic system of claim 11, wherein the component is selected from one or more of a sensor and an electrode.

19. The nanofluidic system of claim 11, wherein the system is a nanofluidic transistor, the component comprising electrodes of the nanofluidic transistor, a first electrode being embedded in the permanent support adjacent to and at a location along a length of the nanochannel array, a second electrode being located adjacent to a first distal end of the nanochannel apparatus, and a third electrode being located adjacent to a second distal end of the nanochannel apparatus, such that fluid flow through the nanochannel apparatus is controllable.

20. The nanofluidic system of claim 11, wherein the system is a nanofluidic sensor, the component comprising one or more sensors selected from a nanowire-based sensor, a single electron transistor, an optical detector, an optoelectronic structure, and a vertical cavity surface emitting laser, at least one of the sensors optionally being embedded in the permanent support adjacent to and at a location along a length of the nanochannel array.

21. A method of fabricating a nanochannel apparatus comprising:
encasing an array of nanowires in a support; and
forming an array of nanochannels in situ through the support in locations of the nanowires, such that distal ends of the nanochannels are exposed, the support being a permanent support for the nanochannels of the apparatus.

22. The method of fabricating of claim 21, wherein forming an array of nanochannels comprises selectively removing the array of nanowires from the support.

23. The method of fabricating of claim 21, wherein encasing an array of nanowires comprises depositing a material of the support on a horizontal surface of a substrate to envelop the nanowires, the method of fabricating optionally further comprising selectively removing the substrate either before or after the array of nanochannels is formed.

24. The method of fabricating of claim 21, further comprising:
creating a pair of islands that are spaced apart and parallel in a first layer on a horizontal surface of a substrate, a vertical surface of one or both islands being a (111) lattice plane of the first layer; and
growing the array of nanowires in situ from the vertical (111) surface of one of the islands to a vertical surface of another of the islands, such that the grown nanowires are horizontally oriented relative to the horizontal surface of the substrate.

25. The method of fabricating of claim 24, wherein encasing an array of nanowires comprises depositing a material of the support in a trench formed by the pair of islands to envelop the array of nanowires, the nanowires being horizontally suspended across the trench during depositing.

26. The method of fabricating of claim 25, wherein forming an array of nanochannels comprises:
removing a section of the support that encases the array of nanowires at an interface between the nanowires and one or both of the islands; and
selectively removing the array nanowires from the support.

27. The method of fabricating of claim 21, further comprising:
providing a substrate that has a [111]-oriented crystal lattice, such that the substrate has a horizontal surface that is a (111) lattice plane; and
growing the nanowires from the horizontal surface, such that the nanowires are vertically oriented relative to the horizontal surface of the substrate.

28. The method of fabricating of claim 27, wherein forming an array of nanochannels comprises:
creating an opening in the substrate that is coaxial with the array of nanowires to expose ends of the nanowires that are adjacent to the substrate;
removing a surface portion of the support to expose respective distal ends of the nanowires; and
selectively removing the nanowires from the support.

29. The method of fabricating of claim 21, further comprising:
embedding a component in the support adjacent to and at a location along a length of the array of nanowires, such that the component forms at least a portion of the formed array of nanochannels, wherein the component is selected from one of a sensor and an electrode.

30. The method of fabricating of claim 21, further comprising:
growing a thermal oxide on the nanowires of the array prior to encasing, such that a diameter of each nanowire and a diameter of a corresponding formed nanochannel are reduced by a thickness of the thermal oxide.
